(19) United States
(12) Patent Application Publication
(10) Pub. No.: US 2024/0420452 A1
(43) Pub. Date: Dec. 19, 2024

(54) METHOD OF CELL-CLUSTER ANALYSIS

(71) Applicant: Chang Gung Memorial Hospital, Linkou, Taoyuan (TW)

(72) Inventors: Hsiang-Sheng Wang, Taoyuan (TW); Tse-Ching Chen, Taoyuan (TW)

(21) Appl. No.: 18/742,623

(22) Filed: Jun. 13, 2024

Related U.S. Application Data
(60) Provisional application No. 63/508,419, filed on Jun. 15, 2023.

(51) Int. Cl. G06V 10/762; G06T 7/00; G06V 10/766; G06V 20/69

(52) U.S. Cl. CPC G06V 10/762; G06T 7/0012; G06V 10/766; G06V 20/69; G06T 2207/20076; G06T 2207/30024; G06T 2207/30204; G06T 2207/30242

(57) ABSTRACT

A method of cell-cluster analysis includes: for each of cell-image portions of a section image, determining a number of proto-oncogenes and a number of specific chromosomes; performing statistical analysis to obtain a statistical result based on the numbers of proto-oncogenes determined respectively for the cell-image portions and the numbers of specific chromosomes determined respectively for the cell-image portions; and according to a thickness of an object tissue section, a representative radius related to cells of the object tissue section and a plurality of distribution data sets, performing regression analysis on the statistical result to obtain a result of cell-cluster analysis that indicates, for each of estimated cell clusters, a ratio of a number of cells that belong to the estimated cell cluster to a total number of the cells of the object tissue section.

### CROSS-REFERENCE TO RELATED APPLICATION

This application claims the benefit of U.S. Provisional Patent Application No. 63/508,419, filed on Jun. 15, 2023, and incorporated by reference herein in its entirety.

### FIELD

The disclosure relates to a method of cell-cluster analysis.

### BACKGROUND

A human epidermal growth factor receptor 2 (HER2) oncogene is located on human chromosome 17, and is associated with pathogenesis of human breast cancer. HER2 overexpression can lead to proliferation, transformation and migration of a breast cancer cell. In clinical practice, fluorescent in situ hybridization (FISH) is a technique in which fluorescent probes are utilized to detect and localize an HER2 oncogene and a chromosome 17 centromere locus (hereinafter also referred to as CEP17). With the help of FISH, a medical professional is able to determine a copy number of HER2 oncogenes according to a number of fluorescence signals that are generated in response to HER2 oncogenes detection, and to determine a copy number of CEP17s according to a number of fluorescence signals that are generated in response to CEP17s detection. A ratio of the copy number of HER2 oncogenes to the copy number of CEP17s (i.e., a HER2/CEP17 ratio) can be used to determine whether a diagnosis result is HER2-positive or HER2-negative.

Because of a stereoscopic structure of a cell, a tissue section often contains only cell portions, rather than whole cells. As a result, a relatively-thin tissue section may make the medical professional underestimate a copy number of HER2 oncogenes or a copy number of CEP17s when using FISH, resulting in a false-negative diagnosis result. On the other hand, a relatively-thick tissue section may contain overlapping cells, which is troublesome for the medical professional to correctly distinguish cells from each other and to accurately count the copy number of HER2 oncogenes and the copy number of CEP17s. Consequently, it is difficult to make a tissue section that allows the medical professional to clearly distinguish all of the HER2 oncogenes and CEP17s in a cell which facilitates observation and counting.

### SUMMARY

Therefore, an object of the disclosure is to provide a method of cell-cluster analysis that can alleviate at least one of the drawbacks of the prior art.

According to the disclosure, the method includes steps of:
obtaining a section image that is related to an object tissue section, the section image including a plurality of cell-image portions that correspond respectively to a plurality of cells of the object tissue section;
for each of the cell-image portions, determining a number of proto-oncogenes according to a number of first markers which are shown in the cell-image portion, each of which indicates a proto-oncogene, and determining a number of specific chromosomes according to a number of second markers which are shown in the cell-image portion, each of which indicates a specific chromosome;
performing statistical analysis based on the numbers of proto-oncogenes determined respectively for the cell-image portions and the numbers of specific chromosomes determined respectively for the cell-image portions to obtain a statistical result that indicates, for each of a plurality of preliminary cell clusters, a number of a group of the cells of the object tissue section that belong to the preliminary cell cluster, each of the preliminary cell clusters corresponding to a distinct pair of one of the numbers of proto-oncogenes and one of the numbers of specific chromosomes; and
according to a thickness of the object tissue section, a representative radius related to the cells of the object tissue section, and a plurality of distribution data sets that correspond respectively to various reference hit probabilities each related to a reference tissue section, performing regression analysis on the statistical result to obtain a result of cell-cluster analysis that indicates, for each of estimated cell clusters, a ratio of a number of cells that belong to the estimated cell cluster to a total number of the cells of the object tissue section, the cells of the estimated cell cluster having an identical number of proto-oncogenes and an identical number of specific chromosomes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an analysis system according to an embodiment of the disclosure.

FIG. 2 is a schematic diagram illustrating examples of relative positions of a cell with respect to a tissue section that has a thickness greater than a diameter of the cell.

FIG. 3 is a schematic diagram illustrating examples of relative positions of a cell with respect to a tissue section that has a thickness less than a diameter of the cell.

FIG. 4 is a schematic diagram illustrating an example of distribution data sets stored in the analysis system according to the embodiment of the disclosure.

FIG. 5 is a flow chart illustrating a method of cell-cluster analysis according to an embodiment of the disclosure.

FIG. 6 is a schematic diagram illustrating an examples of a part of a section image.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

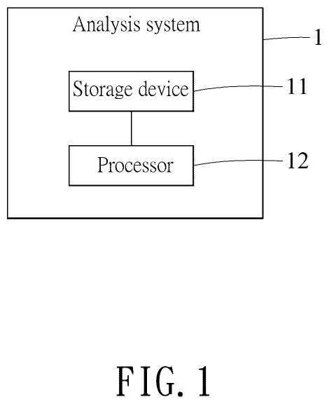

Referring to FIG. 1, an embodiment of an analysis system 1 according to the disclosure is illustrated. The analysis system 1 includes a storage device 11 and a processor 12. The processor 12 is electrically connected to the storage device 11.

The processor 12 may be implemented by a central processing unit (CPU), a microprocessor, a micro control unit (MCU), a system on a chip (SoC), or any circuit configurable/programmable in a software manner and/or hardware manner to implement functionalities discussed in this disclosure.

The storage device 11 may be implemented by random access memory (RAM), double data rate synchronous dynamic random access memory (DDR SDRAM), read only memory (ROM), programmable ROM (PROM), flash memory, a hard disk drive (HDD), a solid state disk (SSD), electrically-erasable programmable read-only memory (EEPROM) or any other volatile/non-volatile memory devices, but is not limited thereto.

The storage device 11 is configured to store a plurality of distribution data sets that correspond respectively to various reference hit probabilities each related to a reference tissue section. Each of the reference hit probabilities is a probability that the reference tissue section contains any cell having one of a proto-oncogene (e.g., a human epidermal growth factor receptor 2, HER2, oncogene, hereinafter also referred to as HER2) and a specific chromosome (e.g., human chromosome 17, hereinafter also referred to as CEP17 or CEP). In this embodiment, the distribution data sets include m number of distribution data sets that correspond respectively to m number of reference hit probabilities, where m is a positive integer. Each of the distribution data sets includes p number of pieces of distribution data that are related respectively to p number of reference cell clusters, where p is a positive integer.

Each of the reference cell clusters corresponds to a distinct pair of a number n and a number k, and is composed of a plurality of cells each having n number of proto-oncogenes and k number of specific chromosomes, where each of n and k is an integer variable. Hereinafter, the distinct pair of a number n and a number k is also referred to as the distinct pair (n,k). Each of the pieces of distribution data includes n×k number of reference probabilities P_{i,j}. Each of the n×k number of reference probabilities P_{i,j} is a probability that a cell in the corresponding one of the reference cell clusters has i number of specific chromosomes and j number of proto-oncogenes, where i is an integer ranging from zero to k, and j is an integer ranging from zero to n. It is worth to note that for a cell that actually has N number of proto-oncogenes and K number of specific chromosomes where each of N and K is a non-negative integer, since a tissue section may contain either whole cells or only a cell portions, a number of the proto-oncogenes of the cells contained in the tissue section will be determined to be J that is an integer not greater than N and a number of the specific chromosomes of the cells contained in the tissue section will be determined to be/that is an integer not greater than K.

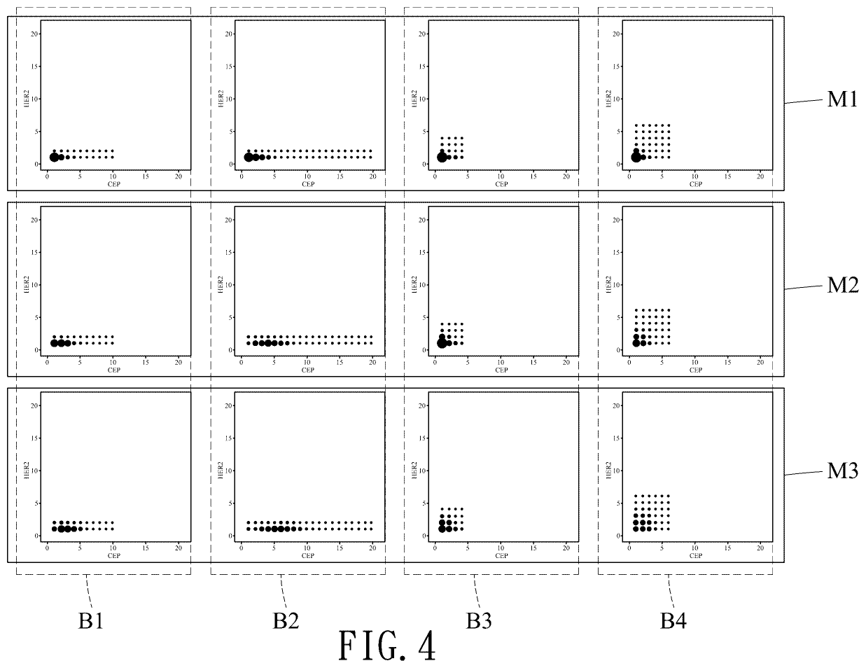

For example, referring to FIG. 4, the storage device 11 stores three (i.e., m=3) distribution data sets (M1, M2, M3) that correspond respectively to three reference hit probabilities, 0.1, 0.2, 0.3, and each of the three distribution data sets (M1, M2, M3) includes four (i.e., p=4) pieces of distribution data that are related respectively to four reference cell clusters. The four reference cell clusters correspond respectively to four distinct pairs (n=10, k=2), (n=20, k=2), (n=4, k=4), (n=6, k=6). Three pieces of distribution data respectively included in the three distribution data sets (M1, M2, M3) that correspond to the same distinct pair (n=10, k=2) compose a first distribution data group (B1); another three pieces of distribution data respectively included in the three distribution data sets (M1, M2, M3) that correspond to the same distinct pair (n=20, k=2) compose a second distribution data group (B2); still another three pieces of distribution data respectively included in the three distribution data sets (M1, M2, M3) that correspond to the same distinct pair (n=4, k=4) compose a third distribution data group (B3); and further another three pieces of distribution data respectively included in the three distribution data sets (M1, M2, M3) that correspond to the same distinct pair (n=6, k=6) compose a fourth distribution data group (B4). Each of the pieces of distribution data presents a probability distribution map, wherein a horizontal axis of the probability distribution map corresponds to a number of proto-oncogenes (i.e., HER2), and a vertical axis of the probability distribution map corresponds to a number of specific chromosomes (i.e., CEP). Each of the n×k number of reference probabilities P_{i,j} is illustrated as a dot in FIG. 4, and a size of the dot positively correlates with the reference probability. That is to say, the greater the size of the dot, the higher the reference probability.

Each of the m number of reference hit probabilities ranges from 0.01 to 0.99, and is expressed as

$$\frac{L}{2 R + L} ,$$

where L represents a thickness of the reference tissue section, and R represents a representative radius related to cells of the reference tissue section. A derivation of the aforementioned mathematical formula for a reference hit probability is described as follows.

For a conditional probability

$$P ( S \vert C ) = \frac{P ( S ⋂ C )}{P ( C )} ,$$

S represents an event that any one of a proto-oncogene and a specific chromosome exists in a reference tissue section, C represents an event that a reference tissue section includes any cell, P(C) represents a probability that a reference tissue section includes any cell, P(S∩C) represents a probability that a reference tissue section including any cell and any one of a proto-oncogene and a specific chromosome exists in the reference tissue section, and the conditional probability P(S|C) is a probability that any one of a proto-oncogene and a specific chromosome exists in a reference tissue section given that the reference tissue section includes any cell. Since any reference tissue section must include any cell, P(C)=1 and P(S|C)=P(S∩C). Because each of a proto-oncogene and a specific chromosome is randomly and evenly distributed in a cell, the probability P(S∩C) can be expressed as:

$$P ( S ∩ C ) = P ( {V}_{portion} ∩ {V}_{whole} ) = \frac{{V}_{p o r t i o n}}{{V}_{w h o l e}} = \frac{{V}_{p o r t i o n}}{\frac{4}{3} π {R}^{3}} ,$$

where Vₚₒᵣₜᵢₒₙ represents a volume of a portion of a cell contained in a reference tissue section (hereinafter also referred to as a portion volume), V_{whole} represents a volume of the whole of a cell (hereinafter also referred to as a whole volume) where the cell is assumed to be a sphere having the representative radius R.

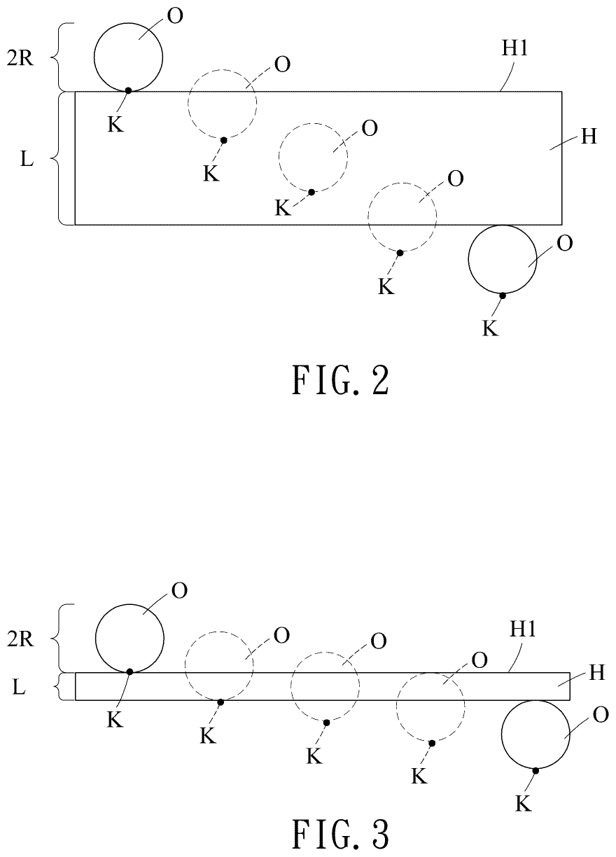

Referring to FIGS. 2 and 3, a sectional plane of a reference tissue section is assumed to be a rectangle (H), wherein a top edge (H1) of the rectangle (H) corresponds to a top plane of the reference tissue section, and a side edge of the rectangle (H) corresponds to a thickness of the reference tissue section and has a length of L. A sectional plane of a cell passing through a center of the cell (i.e., the sphere) is assumed to be a circle (O) having the representative radius R, and a point on a circumference of the circle (O) is regarded as a reference point (K). A Y-axis of a Cartesian coordinate system extends in a direction perpendicular to the top edge (H1), and the top edge (H1) corresponds to an equation Y=0.

In a first scenario as shown in FIG. 2 where the side edge of the rectangle (H) is not less than a diameter of the circle (O), i.e., L≥2R, and the circle (O) moves down in a manner where starting from a position where the circle (O) touches the rectangle (H), the circle (O) passes through the rectangle (H) and then detaches from the rectangle (H), a Y-coordinate of the reference point (K) would change from Y=0 to Y=L+2R, and the portion volume (i.e., Vₚₒᵣₜᵢₒₙ) would increase from zero to

$$\frac{4}{3} π {R}^{3}$$

and then decrease back to zero. An average of the portion volume (hereinafter also referred to as an average volume) during the circle (O) moving down is defined as:

$$\overline{{V}_{portion}} = \frac{{\int }_{0}^{2 R + L} {V}_{p o r t i o n} dy}{{\int }_{0}^{2 R + L} dy} .$$

The reference hit probability is calculated as a ratio of the average volume to the whole volume, and is equal to:

$$\frac{\overline{{V}_{portion}}}{{V}_{whole}} = \frac{{\int }_{0}^{2 R + L} {V}_{p o r t i o n} dy}{\frac{4}{3} π {R}^{3} {\int }_{0}^{2 R + L} dy} = \frac{{\int }_{0}^{2 R} {V}_{p o r t i o n} dy + {\int }_{2 R}^{L} {V}_{p o r t i o n} dy + {\int }_{L}^{2 R + L} {V}_{p o r t i o n} dy}{\frac{4}{3} π {R}^{3} ( 2 R + L )} ,$$

where

$${\int }_{0}^{2 R} {V}_{portion} dy$$

is referred to as a first partial volume

$${\int }_{2 R}^{L} {V}_{portion} dy$$

is referred to as a second partial volume, and

$${\int }_{L}^{2 R + L} {V}_{portion} dy$$

is referred to as a third partial volume. The first partial volume is identical to the third partial volume, and the second partial volume is equal to

$$\frac{4}{3} π {R}^{3} .$$

According to the spherical cap volume formula, the reference hit probability (i.e., the ratio of the average volume to the whole volume) can be calculated as:

$$\frac{\overline{{V}_{portion}}}{{V}_{w h o l e}} = \frac{2 {\int }_{0}^{2 R} {V}_{p o r t i o n} dy + \frac{4}{3} π {R}^{3} {\int }_{2 R}^{L} dy}{\frac{4}{3} π {R}^{3} ( 2 R + L )} = \frac{L}{2 R + L} .$$

Similarly, in a second scenario as shown in FIG. 3 where the side edge of the rectangle (H) is less than the diameter of the circle (O), i.e., L<2R, and the circle (O) moves down in a manner where starting from a position where the circle (O) touches the rectangle (H), the circle (O) passes through the rectangle (H) and then detaches from the rectangle (H), the reference hit probability can be calculated as:

$$\frac{\overline{{V}_{portion}}}{{V}_{w h o l e}} = \frac{{\int }_{0}^{2 R + L} {V}_{p o r t i o n} dy}{\frac{4}{3} π {R}^{3} {\int }_{0}^{2 R + L} dy} = \frac{{\int }_{0}^{L} {V}_{p o r t i o n} dy + {\int }_{L}^{2 R} {V}_{p o r t i o n} dy + {\int }_{2 R}^{2 R + L} {V}_{p o r t i o n} dy}{\frac{4}{3} π {R}^{3} ( 2 R + L )} ,$$

where

$${\int }_{0}^{L} {V}_{portion} dy$$

is referred to as a fourth partial volume,

$$\\ {\int }_{L}^{2 R} {V}_{portion} dy$$

is referred to as a fifth partial volume, and

$$\\ {\int }_{2 R}^{2 R + L} {V}_{portion} dy$$

is referred to as a sixth partial volume. The fourth partial volume is identical to the sixth partial volume, and the fifth partial volume can be calculated by subtracting two volumes of spherical caps from a volume of a sphere. According to the spherical cap volume formula, the reference hit probability can be calculated as:

$$\\ \frac{\overline{{V}_{port ι on}}}{{V}_{whole}} = \frac{L}{2 R + L} .$$

In brief, in either the first scenario where the side edge of the rectangle (H) is not less than a diameter of the circle (O), i.e., L≥2R, or the second scenario where the side edge of the rectangle (H) is less than the diameter of the circle (O), i.e., L<2R, the reference hit probability is always equal to

$$\\ \frac{L}{2 R + L} .$$

For one of the p number of pieces of distribution data included in one of the m number of distribution data sets, each of the n×k number of reference probabilities P_{i,j} is calculated as:

$$\\ {P}_{i , j} = {C}_{j}^{{}_{} n} {P ( S \vert C )}^{j} {( 1 - P ( S \vert C ) )}^{n - j} {C}_{i}^{{}_{} k} {P ( S \vert C )}^{i} {( 1 - P ( S \vert C ) )}^{k - i} ,$$

wherein the conditional probability P(S|C) is substituted by one of the m number of reference hit probabilities to which said one of the m number of distribution data sets corresponds.

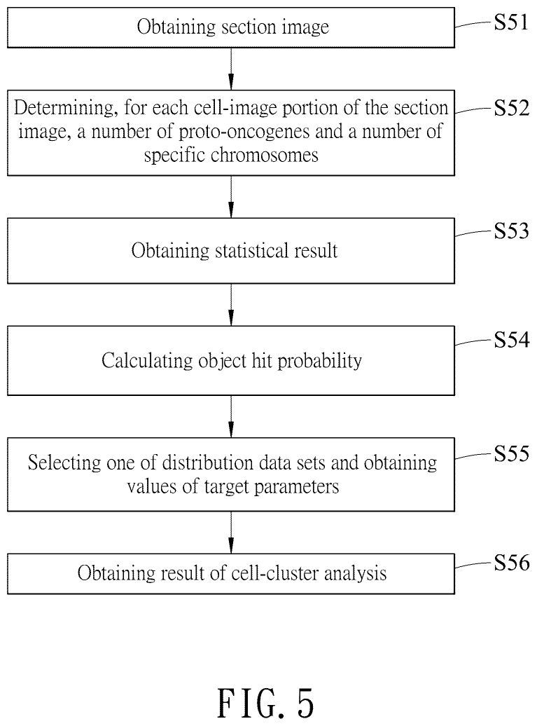

Referring to FIG. 5, an embodiment of a method of cell-cluster analysis according to the disclosure is illustrated. The method is to be implemented by the processor 12 of the analysis system 1 that is previously described. The method includes steps S51 to S56 delineated below.

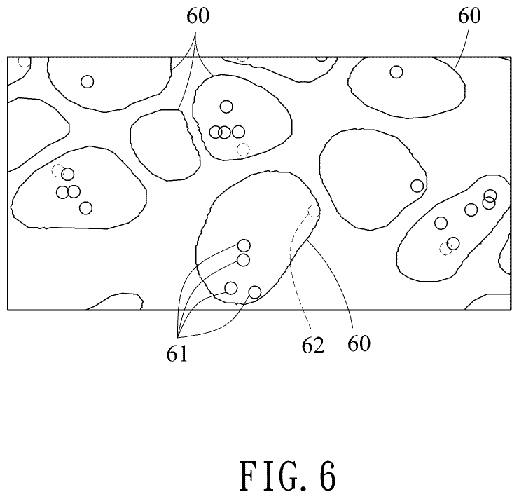

In step S51, the processor 12 obtains a section image that is related to an object tissue section. The section image includes a plurality of cell-image portions that correspond respectively to a plurality of cells of the object tissue section. In this embodiment, the section image is obtained by using techniques of fluorescent in situ hybridization (FISH). FIG. 6 illustrates an examples of a part of the section image. In FIG. 6, each of a plurality of regions 60 that is surrounded by an irregular solid line (i.e., non-circle) corresponds to one of the cell-image portions, each of a plurality of first markers 61 indicates a proto-oncogene (i.e., HER2), and each of a plurality of second markers 62 indicates a specific chromosome (i.e., CEP17).

In step S52, for each of the cell-image portions, the processor 12 determines a number of proto-oncogenes according to a number of the first markers 61 which are shown in the cell-image portion, and determines a number of specific chromosomes according to a number of the second markers 62 which are shown in the cell-image portion. It is worth to note that in this embodiment, the processor 12 utilizes an image-viewer-and-annotation system to annotate the proto-oncogenes with the first markers 61 and the specific chromosomes with the second markers 62 in the section image, and to count the number of the first markers 61 and the number of the second markers 62. The image-viewer-and-annotation system is built by using R programming language (version 4.1.0) and Comprehensive R Archive Network (CRAN) packages. The CRAN packages include packages of “shiny” (version 1.6.0), “shinydashboard” (version 0.7.1), “shinydashboardPlus” (version 2.0.1), “shinyjqui” (version 0.4.0), “shinyjs” (version 2.0.0), “shinyWidgets” (version 0.6.0) and “leaflet” (version 2.0.4.1).

In step S53, the processor 12 performs statistical analysis based on the numbers of proto-oncogenes determined respectively for the cell-image portions and the numbers of specific chromosomes determined respectively for the cell-image portions to obtain a statistical result. The statistical result indicates, for each of a plurality of preliminary cell clusters, a number of a group of the cells of the object tissue section that belong to the preliminary cell cluster. Each of the preliminary cell clusters corresponds to a distinct pair of one of the numbers of proto-oncogenes and one of the numbers of specific chromosomes. In particular, each of the preliminary cell clusters corresponds to a distinct pair of a number x and a number y, and is composed of a plurality of cells each having x number of proto-oncogenes and y number of specific chromosomes, where each of x and y is an integer variable. Hereinafter, the distinct pair of a number x and a number y is also referred to as the distinct pair (x, y). Table 1 below shows an example of the statistical result where four preliminary cell clusters (V1, V2, V3, V4) that respectively correspond to four distinct pairs (x=1, y=1), (x=2, y=2), (x=4, y=2), (x=8, y=2) are present.

TABLE 1

| Preliminary | Numbers | Numbers of | |
|---|---|---|---|
| cell | of proto- | specific | Number |
| cluster | oncogenes (x) | chromosomes (y) | of cells |
| V1 | 1 | 1 | X₁ |
| V2 | 2 | 2 | X₂ |
| V3 | 4 | 2 | X₃ |
| V4 | 8 | 2 | X₄ |

Subsequently, in steps 54 to 56, according to the distribution data sets, a thickness of the object tissue section, and a representative radius related to the cells of the object tissue section, the processor 12 performs regression analysis on the statistical result to obtain a result of cell-cluster analysis. The result of cell-cluster analysis indicates, for each of estimated cell clusters, a ratio of a number of cells that belong to the estimated cell cluster to a total number of the cells of the object tissue section. The cells of the estimated cell cluster have an identical number of proto-oncogenes and an identical number of specific chromosomes.

Specifically, in step S54, the processor 12 calculates an object hit probability based on the thickness of the object tissue section and the representative radius related to the cells of the object tissue section. Particularly, the object hit probability is expressed as

$$\\ \frac{{L}^{{}_{} ″}}{2 {R}^{{}_{} ″} + {L}^{{}_{} ″}} ,$$

where L″ represents the thickness of the object tissue section, and R″ represents the representative radius related to cells of the object tissue section. In this embodiment, the representative radius related to the cells of the object tissue section is an average of radii respectively of all cells of the object tissue section.

In step S55, based on the object hit probability, the m number of distribution data sets, and for each of the preliminary cell clusters, a number of a group of the cells of the object tissue section that belong to the preliminary cell cluster, the processor 12 selects one of the m number of distribution data sets and obtains p number of values respectively of p number of target parameters that respectively correspond to the p number of reference cell clusters.

More specifically, the processor 12 selects one of the m number of distribution data sets that corresponds to one of the m number of reference hit probabilities which matches the object hit probability. Then, for an r^{th} one of the preliminary cell clusters, the processor 12 determines, based on the statistical analysis, an equation

$$\\ {X}_{r} = {\sum }_{q = 1}^{p} {P}_{x , y}^{{}_{} q} \times {a}_{q} ,$$

where r is a positive integer ranging from one to a number of the preliminary cell clusters, q is a positive integer ranging from one to p, Xᵣ represents a number of a group of the cells of the object tissue section that belong to the r^{th} one of the preliminary cell clusters, P_{x,y}^{q} represents one of the n×k number of reference probabilities included in a q^{th} one of the p number of pieces of distribution data, a_{q} is a q^{th} one of p number of target parameters that corresponds to a q^{th} one of the p number of reference cell clusters. It should be noted that for one of the preliminary cell clusters that corresponds to a distinct pair (x, y), only those of the pieces of distribution data each corresponding to a distinct pair (n,k) where n is not less than x and k is not less than y are used to formulate the equation for the one of the preliminary cell clusters. Thereafter, the processor 12 solves the equations thus determined respectively for the preliminary cell clusters to obtain the values respectively of the target parameters. In particular, the processor 12 solves the equations by using regression techniques to obtain approximate values of the target parameters.

Take information provided in Table 1 and FIG. 4 for example. Given that the object hit probability calculated in step S54 is 0.3, the processor 12 would select one of the three distribution data sets (M3) (hereinafter is also referred to as the M3 data set) that corresponds to one of the three reference hit probabilities which matches the object hit probability (i.e., 0.3). As shown in Table 1, for a first one of the preliminary cell clusters (V1) which corresponds to (x=1, y=1) and to which X₁ number of cells belong, since there are four pieces of distribution data included in the M3 data set that respectively correspond to four distinct pairs (n=10, k=2), (n=20, k=2), (n=4, k=4), (n=6, k=6) each of which n is not less than x and k is not less than y, the processor 12 would determine a first equation as X₁=P_{1,1}¹×a₁+P_{1,1}²×a₂+P_{1,1}³×a₃+P_{1,1}⁴×a₄, wherein four reference probabilities P_{1,1}¹, P_{1,1}², P_{1,1}³, P_{1,1}⁴ are respectively obtained from the four pieces of distribution data included in the M3 data set thus selected. Similarly, for a second one of the preliminary cell clusters (V2) which corresponds to (x=2, y=2) and to which X₂ number of cells belong, since there are four pieces of distribution data included in the M3 data set that respectively correspond to the four distinct pairs (n=10, k=2), (n=20, k=2), (n=4, k=4), (n=6, k=6) each of which n is not less than x and k is not less than y, the processor 12 would determine a second equation as X₂=P_{2,2}¹×a₁+P_{2,2}²×a₂+P_{2,2}³×a₃+P_{2,2}⁴×a₄. For a third one of the preliminary cell clusters (V3) which corresponds to (x=4, y=2) and to which X₃ number of cells belong, since there are four pieces of distribution data included in the M3 data set that respectively correspond to the four distinct pairs (n=10, k=2), (n=20, k=2), (n=4, k=4), (n=6, k=6) each of which n is not less than x and k is not less than y, the processor 12 would determine a third equation as X₃=P_{4,2}¹×a₁+P_{4,2}²×a₂+P_{4,2}³×a₃+P_{4,2}⁴×a₄. For a fourth one of the preliminary cell clusters (V4) which corresponds to (x=8, y=2) and to which X₄ number of cells belong, since there are only two pieces of distribution data included in the M3 data set that respectively correspond to two distinct pairs (n=10, k=2), (n=20, k=2) each of which n is not less than x and k is not less than y, the processor 12 would determine a fourth equation as X₄=P_{8,2}¹×a₁+P_{8,2}²×a₂. After that, the processor 12 solves the first, second, third and fourth equations by using regression techniques to obtain approximate values of the target parameters a₁, a₂, a₃, a₄.

In step S56, the processor 12 designates the p number of reference cell clusters respectively as the estimated cell clusters. In addition, the processor 12 designates the values of the target parameters respectively as the ratios respectively for the estimated cell clusters, and takes the values of the target parameters together as the result of cell-cluster analysis. In particular, the result of cell-cluster analysis is expressed as

$$\\ M = {\sum }_{q = 1}^{p} {a}_{q} {T}_{{k}_{q}}^{{}_{} {n}_{q}} ,$$

where M is the result of cell-cluster analysis, Tₖ_{_{q}}ⁿ^{_{q}} represents a sum of reference probabilities included in the distribution data set that are related to one of the reference cell clusters which is composed of a plurality of cells each having n_{q} number of proto-oncogenes and k_{q} number of specific chromosomes, and a_{q} represents a ratio of a number of a group of the cells of the object tissue section that belong to a q^{th} one of the estimated cell clusters to a total number of the cells of the object tissue section. Furthermore, Tₖ_{_{q}}ⁿ^{_{q}} is calculated as

$$\\ {T}_{{k}_{q}}^{{}_{} {n}_{q}} = {\sum }_{j = 0}^{{n}_{q}} {\sum }_{i = 0}^{{k}_{q}} {C}_{j}^{{}_{} {n}_{q}} {P ( S \vert C )}^{j} {( 1 - P ( S \vert C ) )}^{{n}_{q} - j} {C}_{i}^{{}_{} {k}_{q}} {P ( S \vert C )}^{i} {( 1 - P ( S \vert C ) )}^{{k}_{q} - i} .$$

In one embodiment, the processor 12 further outputs the result of cell-cluster analysis exemplarily via a display or a printer.

To sum up, for the method of cell-cluster analysis according to the disclosure, the statistical result is obtained based on the section image to indicate, for each of the preliminary cell clusters, the number of the group of the cells of the object tissue section that belong to the preliminary cell cluster, and then regression analysis is performed on the statistical result to obtain the result of cell-cluster analysis that indicates, for each of the estimated cell clusters, the ratio of the number of cells that belong to the estimated cell cluster to the total number of the cells of the object tissue section. Conventionally, the thickness of the object tissue section may cause discrepancy between counted numbers of the proto-oncogenes and the specific chromosomes according to the object tissue section and actual numbers of the proto-oncogenes and the specific chromosomes in the real world. However, with the assist of mathematical statistics, the method of cell-cluster analysis according to the disclosure may help alleviate such discrepancy.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of cell-cluster analysis, comprising:
obtaining a section image that is related to an object tissue section, the section image including a plurality of cell-image portions that correspond respectively to a plurality of cells of the object tissue section;
for each of the cell-image portions, determining a number of proto-oncogenes according to a number of first markers which are shown in the cell-image portion, each of which indicates a proto-oncogene, and determining a number of specific chromosomes according to a number of second markers which are shown in the cell-image portion, each of which indicates a specific chromosome;
performing statistical analysis based on the numbers of proto-oncogenes determined respectively for the cell-image portions and the numbers of specific chromosomes determined respectively for the cell-image portions to obtain a statistical result that indicates, for each of a plurality of preliminary cell clusters, a number of a group of the cells of the object tissue section that belong to the preliminary cell cluster, each of the preliminary cell clusters corresponding to a distinct pair of one of the numbers of proto-oncogenes and one of the numbers of specific chromosomes; and
according to a thickness of the object tissue section, a representative radius related to the cells of the object tissue section, and a plurality of distribution data sets that correspond respectively to various reference hit probabilities each related to a reference tissue section, performing regression analysis on the statistical result to obtain a result of cell-cluster analysis that indicates, for each of estimated cell clusters, a ratio of a number of cells that belong to the estimated cell cluster to a total number of the cells of the object tissue section, the cells of the estimated cell cluster having an identical number of proto-oncogenes and an identical number of specific chromosomes.

2. The method as claimed in claim 1, wherein:
each of the reference hit probabilities is a probability that the reference tissue section contains any cell having one of a proto-oncogene and a specific chromosome;
each of the distribution data sets includes p number of pieces of distribution data that are related respectively to p number of reference cell clusters, p being a positive integer;
each of the reference cell clusters corresponds to a distinct pair of a number n and a number k, and is composed of a plurality of cells each having n number of proto-oncogenes and k number of specific chromosomes, each of n and k being an integer variable; and
each of the pieces of distribution data includes n×k number of reference probabilities P_{i,j}, each of the n×k number of reference probabilities P_{i,j} being a probability that a cell in the corresponding one of the reference cell clusters has i number of specific chromosomes and j number of proto-oncogenes, i being an integer ranging from zero to k, j being an integer ranging from zero to n.

3. The method as claimed in claim 2, wherein:
each of the preliminary cell clusters corresponds to a distinct pair of a number x and a number y, and is composed of a plurality of cells each having x number of proto-oncogenes and y number of specific chromosomes, each of x and y being an integer variable;
the distribution data sets include m number of distribution data sets that correspond respectively to m number of reference hit probabilities, m being a positive integer; and
performing regression analysis on the statistical result includes
calculating an object hit probability based on the thickness of the object tissue section and the representative radius related to the cells of the object tissue section,
based on the object hit probability, the m number of distribution data sets, and for each of the preliminary cell clusters, a number of a group of the cells of the object tissue section that belong to the preliminary cell cluster, selecting one of the m number of distribution data sets and obtaining p number of values respectively of p number of target parameters that respectively correspond to the p number of reference cell clusters,
designating the p number of reference cell clusters respectively as the estimated cell clusters, and
designating the values of the target parameters respectively as the ratios respectively for the estimated cell clusters, and taking the values of the target parameters together as the result of cell-cluster analysis.

4. The method as claimed in claim 3, wherein the object hit probability is expressed as
$$\\ \frac{L}{2 R + L} ,$$
where L represents the thickness of the object tissue section, and R represents the representative radius related to cells of the object tissue section.

5. The method as claimed in claim 3, wherein selecting one of the m number of distribution data sets and obtaining p number of values respectively of p number of target parameters includes:
selecting one of the m number of distribution data sets that corresponds to one of the m number of reference hit probabilities which matches the object hit probability,
for an r^{th} one of the preliminary cell clusters, determining, based on the statistical analysis, an equation
$$\\ {X}_{r} = {\sum }_{q = 1}^{p} {P}_{x , y}^{{}_{} q} \times {a}_{q} ,$$
where r is a positive integer ranging from one to a number of the preliminary cell clusters, q is a positive integer ranging from one to p, Xᵣ represents a number of a group of the cells of the object tissue section that belong to the r^{th} one of the preliminary cell clusters, P_{x,y}^{q} represents one of the n×k number of reference probabilities included in a q^{th} one of the p number of pieces of distribution data, a_{q} is a q^{th} one of p number of target parameters that corresponds to a q^{th} one of the p number of reference cell clusters,
solving the equations thus determined respectively for the preliminary cell clusters to obtain the values respectively of the target parameters.

6. The method as claimed in claim 2, wherein each of the n×k number of reference probabilities P_{i,j} is calculated as:
$$\\ {P}_{i , j} = {C}_{j}^{{}_{} n} {P ( S \vert C )}^{j} {( 1 - P ( S \vert C ) )}^{n - j} {C}_{i}^{{}_{} k} {P ( S \vert C )}^{i} {( 1 - P ( S \vert C ) )}^{k - i} ,$$
where S represents an event that any one of a proto-oncogene and a specific chromosome exists in a reference tissue section, C represents an event that a reference tissue section includes any cell, P(S|C) represents a conditional probability of that any one of a proto-oncogene and a specific chromosome exists in a reference tissue section given that the reference tissue section includes any cell.

7. The method as claimed in claim 2, wherein each of the reference hit probabilities is expressed as
$$\\ \frac{L}{2 R + L} ,$$
where L represents a thickness of the reference tissue section, and R represents a representative radius related to cells of the reference tissue section.

8. The method as claimed in claim 1, wherein the result of cell-cluster analysis is expressed as
$$\\ M = {\sum }_{q = 1}^{p} {a}_{q} {T}_{{k}_{q}}^{{}_{} {n}_{q}} ,$$
where M is the result of cell-cluster analysis, Tₖ_{_{q}}ⁿ^{_{q}} represents a sum of reference probabilities included in the distribution data set that are related to one of the reference cell clusters which is composed of a plurality of cells each having n_{q} number of proto-oncogenes and k_{q} number of specific chromosomes, and a_{q} represents a ratio of a number of a group of the cells of the object tissue section that belong to a q^{th} one of the estimated cell clusters to a total number of the cells of the object tissue section.

9. The method as claimed in claim 8, wherein Tₖ_{_{q}}ⁿ^{_{q}} is calculated as
$$\\ {T}_{{k}_{q}}^{{}_{} {n}_{q}} = {\sum }_{j = 0}^{{n}_{q}} {\sum }_{i = 0}^{{k}_{q}} {C}_{j}^{{}_{} {n}_{q}} {P ( S \vert C )}^{j} {( 1 - P ( S \vert C ) )}^{{n}_{q} - j} {C}_{i}^{{}_{} {k}_{q}} {P ( S \vert C )}^{i} {( 1 - P ( S \vert C ) )}^{{k}_{q} - i} ,$$
where S represents an event that any one of a proto-oncogene and a specific chromosome exists in a reference tissue section, C represents an event that a reference tissue section includes any cell, P(S|C) represents a conditional probability of that any one of a proto-oncogene and a specific chromosome exists in a reference tissue section given that the reference tissue section includes any cell.
